(19) United States
(12) Patent Application Publication
(10) Pub. No.: US 2005/0037913 A1
(43) Pub. Date: Feb. 17, 2005

(54) Method for the production of glasses containing bismuth oxide

(76) Inventors: Ulrich Peuchert, Bodenheim (DE); Martin Letz, Klein-Winternheim (DE); Bianca Schreder, Frankfurt (DE); Rudiger Sprengard, Mainz (DE); Joseph S. Hayden, Clarks Summit, PA (US); Paula Vullo, Pittston, PA (US)

Correspondence Address: Striker Striker & Stenby, 103 East Neck Road, Huntington, NY, 11743, US

(21) Appl. No.: 10/489,011

(22) PCT Filed: Sep. 5, 2002
(86) PCT No.: PCT/EP02/09940

(30) Foreign Application Priority Data
Sep. 10, 2001 (DE) 101 44 474.5
Mar. 13, 2002 (DE) 102 11 246.0

(51) Int. Cl. C03B 5/16; C03C 3/068

(52) U.S. Cl. 501/78; 65/134.4; 65/134.5

(57) ABSTRACT

The invention relates to a method for the production of a glass containing bismuth oxide, the use of such a method for the production of optical glasses, in particular glasses for application in optical telecommunications and a glass which may be produced by said method.

The present invention relates to a process for producing a glass containing bismuth oxide, to the use of a process of this type for the production of optical glasses, in particular glasses which are used in optical communication technology, and to a glass producible by the process according to the invention.

Optical amplifier units are one of the key components of modern optical communication technology, in particular WDM technology (WDM=“Wavelength Division Multiplexing”). Hitherto, the prior art has primarily used quartz glasses doped with optically active ions as core glass for such optical amplifiers. Er-doped amplifiers based on SiO₂ allow simultaneous amplification of a plurality of closely adjacent channels differentiated by wavelength in the region around 1.5 μm. However, on account of the fact that the Er in SiO₂ glasses has only a narrow emission band, they are not suitable for the increasing demand for transmission power. The broader the emission band, the greater the transmission power which can be selected.

Accordingly, there is an increase in demand for glasses from which rare earth ions emit over a significantly broader band by comparison with the emission from SiO₂ glasses. In this context, glasses with heavy elements, in particular heavy metal oxide glasses (HMO glasses), are favored in this context. On account of their weak interatomic bonds, these heavy metal oxide glasses have high interatomic electric fields and therefore, on account of greater Stark splitting of unexcited state and excited states, lead to broader emission from the rare earth ions. Glasses containing bismuth oxide are also proposed for use as heavy metal oxides of this type.

However, the glasses containing bismuth oxide have the drawback that under the drastic conditions imposed by the melt, bismuth oxide can be reduced by other components. Elemental bismuth which precipitates out in the form of a fine black deposit impairs the optical properties, in particular the transparency of the glass, meaning that these glasses can no longer be used. Furthermore, if Bi⁰ is present, there is a risk of an alloy being formed with standard crucible materials, in particular Pt. This phenomenon promotes crucible corrosion and leads to alloy particles which can cause undesired problems in fiber design during further processing steps, e.g. the fiber drawing process.

In the prior art, it has previously been proposed to add cerium oxide in order to stabilize the high oxidation state of the bismuth (cf. for example JP 11-317561 and WO 00/23392).

However, the addition of cerium oxide entails significant drawbacks. For example, glasses containing even small quantities of <0.2 Mol % of cerium oxide have a yellowish-orange appearance. Furthermore, the addition of cerium shifts the UV edge of the glass into the region of the Er³⁺emission line at 550 nm. This is also described, for example, in JP 2001-213635 and JP 2001-213636.

To prevent bismuth oxide from being reduced to metallic bismuth even without cerium being added, it is proposed in JP 2001-213636 to limit the melting point to preferably at most 1100° C. However, it has emerged that this method alone is not particularly effective at stabilizing the oxidation state.

Furthermore, U.S. Pat No. 6,198,870 and JP 11-236245 describe the sensitizing action of cerium oxide on the amplification power of Er-doped heavy metal oxide-containing glass fibers. Cerium oxide has a strong absorption in the region of 2700 nm and 3000 nm, which corresponds to the energy difference of the photon transition in the Er³⁺ term diagram from the pumping level to the emitting level. For example, the pumping level can be rapidly depopulated by cross-relaxation. This effect of a cerium oxide co-doping is in Er-doped tellurite glasses is described by Choi et al. in “Enhanced ⁴|_{11/2}→⁴|_{13/2} Transition Rate in Er³⁺/Ce³⁺ Codoped Tellurite Glasses”, Elektron. Lett. 35, 1765-1767 (1999).

Therefore, the object of the present invention was to provide an improved process for producing glasses containing bismuth oxide which in particular allows a glass with improved optical properties to be produced.

The above object is achieved by the embodiments of the present invention which are described in the claims.

In particular the present invention relates to a process for producing a glass containing bismuth oxide, characterized in that during the melting operation oxygen is blown into the melt.

It has been discovered that the oxidation state of bismuth oxide can also be set by means of a particular production process, with the result that doping with cerium to stabilize the oxidation state is no longer necessary. This measure also makes it possible, if necessary, to melt a glass containing bismuth oxide using relatively high melting temperatures.

In the figures:

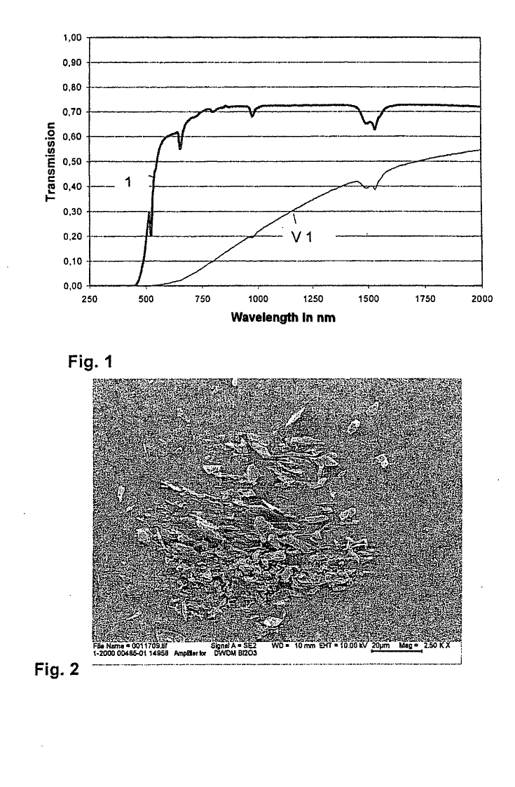

FIG. 1 shows the transmission spectrum of a glass 1 which has been melted using the process according to the invention compared to the transmission spectrum V1 of a Comparative Example.

FIG. 2 shows an electron microscope image of the glass from Comparative Example 1.

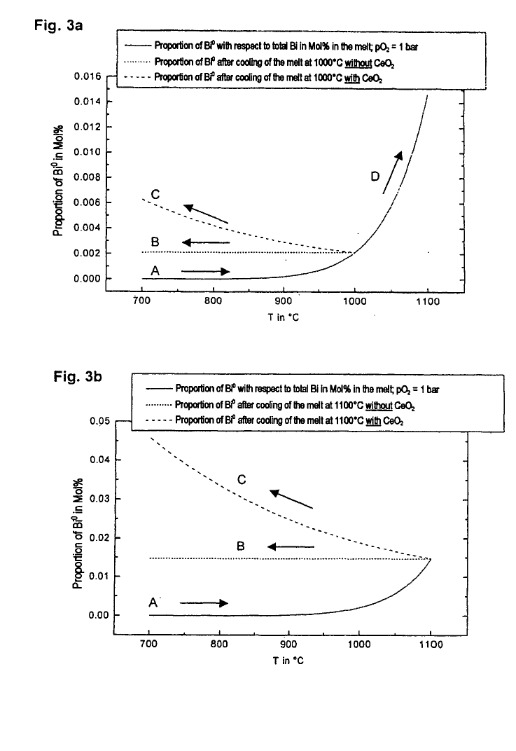

FIG. 3 shows the rise in the proportion of Bi⁰ in the total bismuth oxide content in Mol % as function of the temperature of the melt and if appropriate in the presence of cerium oxide.

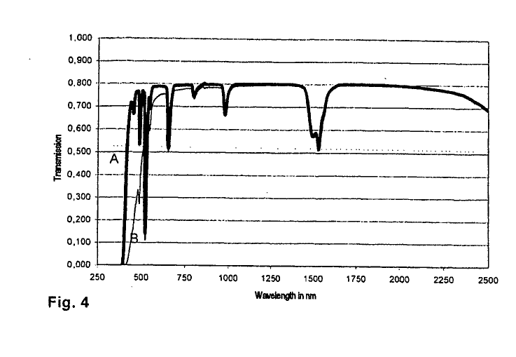

FIG. 4 shows transmission spectra for two glasses which have come into contact with the different crucible materials.

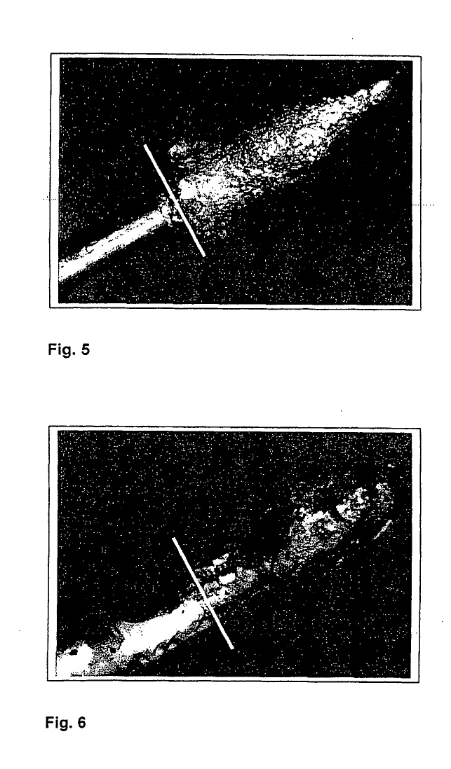

FIG. 5 shows a cleaned platinum electrode after electrochemical measurement carried out on a glass containing bismuth oxide.

FIG. 6 shows a cleaned gold electrode after electrochemical measurements carried out on a glass containing bismuth oxide.

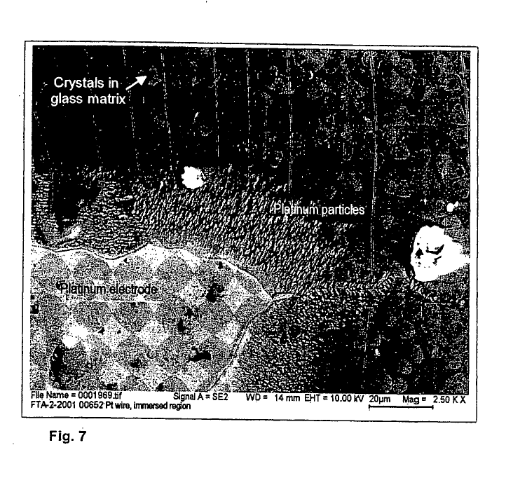

FIG. 7 shows a scanning electron microscope image of an uncleaned platinum electrode with adhering residues of the glass containing bismuth oxide.

According to the present invention, oxygen flows into the melt during the melting operation. The blowing of oxygen into the glass melt, known as oxygen bubbling, is preferably set in such a way that evolution of bubbles can be observed on the surface of the melt. It is particularly preferable for the strength of the oxygen bubbling to be set in such a way that glass melt is not quite thrown out of the crucible.

By way of example, a quantity of preferably 0.1 to 10 l/ min, particularly preferably 0.3 to 5 l/min, of oxygen is blown into a melt. In this case, the melt volume is, for example, 0.5 to 5 liters.

For this purpose, in general at least one tube made from a suitable material, such as for example platinum or a Pt/Au alloy as explained below, is immersed in the melt. With a crucible size of up to 5 l, it will generally be sufficient for just one tube to be immersed in the melt and, by way of example, the quantity of oxygen indicated above to be blown into the melt. However, particularly in the case of relatively large melting crucibles, it is possible for two or more tubes to be immersed in the melt for oxygen bubbling. However, one tube with an internal diameter of up to 10 mm, for example approximately 5 to 6 mm, is generally sufficient for melting crucibles of up to 5 l. A tube of this type is preferably introduced as deep as possible into the melt, for example to depth of 1 cm above the crucible base in the case of melt height of 10 cm.

It is preferable for the oxygen bubbling to be carried out over a period of 30 min to 5 hours, preferably 30 min to 2.5 hours. The duration of the oxygen bubbling can be matched to the melt volume. A greater melt volume should preferably be exposed to this process step for a longer time in relative terms.

The oxygen bubbling should in particular be carried out in the initial phase of melting. In particular during the charging and initial melting of the raw materials, chemical reactions take place in the melt which are favorably influenced by the oxygen bubbling. At a later time, for example after the homogenization and/or refining, it is also possible to dispense with the oxygen bubbling. If appropriate, a stream of oxygen can be passed over the melt in this subsequent stage.

To stabilize the oxidation state of the bismuth oxide, it is sufficient for the oxygen bubbling not to be carried out using dried oxygen.

However, it has been found that the removal of water from the glass melt by oxygen bubbling using dried oxygen has advantageous effects on the amplifying properties of the glass. For example, the drying lengthens the life span of the emitting level, which means that it is possible to make do with a lower pumping power. This makes it possible to increase the efficiency of an amplifier. It is therefore preferable for dry oxygen to be blown into the melt.

A further measure for promoting dewatering of the melt consists in thermally pretreating the batch of starting materials, for example by drying the batch, preferably in vacuo. Therefore, a measure of this type is also preferred. The addition of halogenated oxygen and/or mixtures of carbon tetrachloride and oxygen also promotes the dewatering, and therefore it is also preferable for glass mixtures of this type to be blown into the melt in accordance with certain embodiments of the present invention.

The above measures relating to the drying of the batch or melt can be employed individually or in combination with one another.

After the glass composition has been melted and homogenized, it is possible to allow the glass composition, in accordance with the process of the invention, to be left to stand in order for bubbles to be removed from the glass melt. The standing period may if appropriate also be assisted by stirring and, for example relatively small melted batches of approximately 1 l crucible volume, is carried out over a period of 15 min to 1.5 h, preferably 30 min to 1 h. If the melt volumes are significantly greater, it is also possible to use longer standing times. Surprisingly, it has emerged that the previous step of blowing in oxygen means that the melt is so saturated with oxygen that no reduction of the bismuth oxide in the melt occurs during this standing time even without oxygen bubbling. However, it is also possible for oxygen to be blown over the melt during this time.

FIG. 1 shows the surprising effect of the process according to the invention. Curve 1 represents the transmission curve of a glass from Example 1, for which oxygen bubbling is carried out during its production. This glass has a high maximum transmission of >70%. The theoretically possible maximum of glasses with a refractive index of approximately 2.0 of approx. 80% is not quite reached in the glass from Example 1 on account of the use of slightly impure raw materials. The glass from Comparative Example 1, which has the same composition as the glass from Example 1 and for which oxygen bubbling is not carried out during its production, has a significantly lower transmission (curve V1).

FIG. 2 shows an electron microscope photograph of the glass from Comparative Example 1. The image shows that the glass is not homogenous, but rather has precipitations with a high level of elemental bismuth, in part in the form of an alloy with platinum.

Furthermore, it has been established that even the addition of cerium alone is not sufficient to produce a glass with a good transmission. In this case too, the maximum transmissions obtained are not as good.

FIGS. 3a and 3b show the proportion (in Mol %) of elemental bismuth Bi⁰ in relation to the total bismuth content in Mol % of a cerium oxide-free melt compared to a cerium oxide-containing melt as a function of the temperature. In both cases, prior to heating to over 700° C., the Bi⁰ content is 0 Mol %, and initially rises slowly when the temperature is increased to above 900° C. and then more steeply (curve A). A level of 0.002 Mol % of Bi⁰ is reached at 1000° C. If the cerium oxide-free melt is then not heated further and is then cooled, the Bi⁰ content remains constant at this level (curve B). If a cerium oxide-containing batch is heated, the same rise to 0.002 Mol % of Bi⁰ at 1000° C. results during heating (curve A). Therefore, the presence of cerium oxide has no effect on the Bi⁰ content during heating. If a cerium oxide-containing melt of this type is cooled back to room temperature, however, the Bi⁰ content disadvantageously rises further (curve C). Therefore, these tests demonstrate that addition of cerium oxide has an adverse effect on a glass containing bismuth oxide. FIG. 3b shows the same diagram if the melt is heated to 1100° C. instead of 1000° C.

FIG. 3a also shows that the Bi⁰ content, despite oxygen bubbling, rises steeply beyond a melt temperature of 1100° C. (curve D). Therefore, according to the invention, it is preferable for a melting temperature of at most approximately 1100° C., more preferably at most approximately 1050° C., most preferably at most approximately 1000° C., not to be exceeded by more than 20° C. in the process according to the invention.

Furthermore, it has been discovered that the platinum crucibles which are generally used to melt glasses of this type may be disadvantageous. Even if, in accordance with the process of the invention, there is only a very small quantity of elemental bismuth Bi⁰ in the glass melt, an interaction with the platinum of the crucible or of the tube used for oxygen bubbling or even an electrode used for measurement purposes in the melt was established. FIG. 5 shows a cleaned platinum electrode which has been used for electrochemical measurements carried out on melts of glasses containing bismuth oxide. The part lying to the right of the drawn-on line corresponds to the piece of the electrode which was immersed in the melt. Considerable erosion of the immersed part compared to the unimmersed part of the electrode is clearly apparent.

FIG. 6 shows, by comparison with FIG. 5, a cleaned gold electrode which has likewise been used as an electrode in melts of glasses containing bismuth oxide. There is no evidence of erosion to this electrode. This electrode too has undergone modifications at the surface and in terms of its shape, but these are attributable to the heating of the electrode to 1000° C., i.e. close to the melting point of gold at 1064° C. Erosion as in the Pt electrode was not recorded.

FIG. 7 shows a scanning electron microscope image of an uncleaned platinum electrode which had been used in a corresponding way. The region in the bottom left-hand corner of the image shows the platinum electrode with punctiform runners leading from it. The remaining region represents the glass matrix, in which bright crystals are incorporated. It is once again clearly apparent that the platinum electrode is greatly damaged. Furthermore, a large number of small platinum particles have become detached from the electrode. Furthermore, examination of the electrode using EDX showed that no alloy formation with bismuth had occurred in the electrode. Furthermore, EDX measurements established that the crystals are significantly bismuth-enriched and oxygen-depleated compared to the glass matrix.

FIG. 4 shows that the melting of a glass containing bismuth oxide may also have adverse effects on the transmission of the glass. Curve B shows the transmission spectrum of a glass melted in a platinum crucible at below 1000° C. The transmission at shorter wavelengths is worse than that of a glass melted at approximately the same temperature in a gold crucible (cf. curve A).

It is assumed from these results that the contact between the melt containing bismuth oxide and the platinum disadvantageously shifts the Bi³⁺≈Bi⁰ equilibrium toward Bi⁰ as a result of alloy formation with the platinum:
Bi³⁺≈Bi⁰→Pt/Bi

Furthermore, it is assumed that at the direct interface between glass melt and platinum electrode, the concentration of Bi⁰ rises so greatly that a liquid Pt/Bi alloy is formed and becomes detached from the electrode.

As demonstrated by the only low levels of Bi⁰ in FIGS. 3a and 3b, the process according to the invention is advantageous compared to the prior art even if a platinum crucible is used. However, according to certain embodiments of the process according to the invention, it may be preferable to avoid even these slight interactions with platinum as crucible material. Furthermore, for cost reasons it is of course advantageous for the crucible material not to be attacked by the glass melt. Therefore, according to an embodiment of this type, it is preferable not to use a pure platinum crucible. Instead, a gold crucible can be used for a relatively low melting temperature of at most 1000° C. However, since gold, although still dimensionally stable, is softer than platinum at this temperature, on account of its proximity to the melting point, it is also possible to use gold-coated platinum crucibles. This avoids direct contact between the melt and the platinum but at the same time the gold plating is provided with mechanical support from the layer of platinum below it. A gold coating of this type may, for example, be effected by rolling a gold foil onto platinum, by electrochemical deposition or using other processes which are known from the prior art. Furthermore, Pt/Au alloys are surprisingly also suitable for use as a resistant crucible material of this type; even a gold content of, for example 5% by weight, preferably 10% by weight, in the platinum is sufficient to significantly reduce or even completely prevent corrosion of the crucible material. By way of example, a crucible with an Au/Pt ratio of 95/5 contains only small quantities of platinum but can be used up to a temperature of approximately 1200° C.

In addition to the crucible material, it is preferable for all parts of the melting apparatus which come into contact with the melt to be made from a material as described above.

As a further option, it has been discovered that the application of a positive potential to the platinum crucible makes it possible to reduce corrosion to the platinum, and even prevent such corrosion altogether at temperatures of slightly <1000° C. Therefore, according to one embodiment of the present invention, it is preferable to apply a positive potential to a platinum crucible used for the process according to the invention.

The above measures for preventing corrosion to the crucible can also be employed in combination with one another.

The text which follows describes glass compositions which can preferably be produced using the process according to the invention.

It is preferable for glass compositions of this type to contain at least 10 Mol %, preferably at least 20 Mol %, of bismuth oxide. It is even more preferable for the bismuth oxide content in the glass to be at least 30 Mol %. The upper limit for the bismuth oxide in the glass is preferably 80 Mol %, more preferably 70 Mol %, since crystallization of the glass can easily occur above this value. According to a particularly preferred embodiment, the glass according to the invention contains 30 Mol % to 60 Mol % of bismuth oxide.

Glass compositions containing bismuth oxide of this nature contain at least one rare earth compound as a dopant when they are used as optical amplifier media. The rare earth compound is preferably at least one oxide which is selected from oxides of Pr, Nd, Pm, Sm, Eu, Gd, Tb, Dy, Ho, Er, Tm, Yb and/or Lu. Oxides of the elements Er, Pr, Tm, Nd and/or Dy are particularly preferred.

The rare earth compounds used as dopant are preferably what are known as “optically active compounds”; the term “optically active compounds” is to be understood as meaning compounds which lead to the glass of the invention being capable of stimulated emission when the glass is excited by a suitable pumping source.

It is also possible to use at least two rare earth compounds, in a total quantity of from 0.01 to 15 Mol %, preferably from 0.01 to 8 Mol %. Glasses containing optically active rare earth ions can be co-doped with optically inactive rare earth elements, in order, for example, to lengthen the emission life spans. By way of example, Er can be co-doped with La and/or Y. To increase the pumping efficiency of the amplifier, it is also possible, for example, for Er to be co-doped with further optically active rare earth compounds, such as for example Yb.

Co-doping with Gd may also be effected in order to provide stability against crystallization.

In addition to one or more rare earth compounds, it is if appropriate also possible for Sc and/or Y compounds to be contained in the glass according to the invention.

Doping with other rare earth ions, such as for example Tm, makes it possible to open other wavelength regions, such as for example what is known as the S band between 1420 and 1520 nm in the case of Tm.

Furthermore, to make more efficient use of the excitation light, it is possible to add sensitizers, such as Yb, Ho and Nd, in a suitable quantity, for example 0.005 to 8 Mol %.

Furthermore, the glass may also contain cerium oxide, although this embodiment of the process according to the invention is not preferred. It has been found that oxygen bubbling can advantageously be used to improve the transmission even in the case of cerium-containing glasses.

The amount of each individual rare earth compound is, for example, from 0.005 to 8 Mol %, preferably 0.01 to 5 Mol %, based on oxide.

In addition to the components listed above, the glass compositions produced using the process according to the invention may also contain further oxides in an amount of from 0 to 80 Mol %. Additional oxides of this type may be present in order to set physicochemical or optical properties or to reduce the susceptibility to crystallization.

To improve the fiber drawing properties, in particular when the glass is used for an optical fiber amplifier, it is preferable to add at least one conventional network-forming component, such as SiO₂, B₂O₃, Al₂O₃, GeO₂, etc.

The glass preferably also contains gallium and/or aluminum oxides. In particular Al₂O₃ may be added in order to facilitate the glass formation. Oxides of W and Ga can be used to increase the Δλ, i.e. to broaden the emission cross section.

Furthermore, oxides of elements selected from the group consisting of oxides of the following elements Li, Na, K, Rb, Cs, Mg, Ca, Sr, Ba, Zn, W, Ti, Zr, Cd and/or In may be present.

The addition of alkali metal oxides is particularly advantageous if the glass is to be used for planar applications using the ion exchange technique. It may also be preferable to add Li₂O, since this extends the glass-forming ranges inter alia in HMO glasses. Furthermore, Li₂O is advantageous if an amplifier with a particular good efficiency in the L band is to be generated.

It is preferable to melt a glass composition of the following composition (in Mol %):

| | |
|---|---|
| Bi₂O₃ | 10-80 |
| SiO₂ | 0-60 |
| GeO₂ | 0-30 |
| B₂O₃ | 0-60 |
| Al₂O₃ | 0-50 |
| Ga₂O₃ | 0-50 |
| In₂O₃ | 0-30 |
| WO₃ | 0-30 |
| MoO₃ | 0-30 |
| Nb₂O₅ | 0-30 |
| Ta₂O₅ | 0-15 |
| TiO₂ | 0-30 |
| ZrO₂ | 0-30 |
| SnO₂ | 0-40 |
| M^{I}₂O | 0-40 |
| M^{II}O | 0-30 |
| F and/or Cl | 0-10 |
| SiO₂ + GeO₂ | 0.5-60 |
| B₂O₃ + Al₂O₃ + Ga₂O₃ | 0.5-60 |
| rare earth compound | 0.005-8 (based on |
| | oxide) |

where M^{I} is at least one of Li, Na, K, Rb, Cs, and M^{II} is at least one of Be, Mg, Ca, Sr, Ba and/or Zn.

It is particularly preferable to melt a glass composition having the following composition (in Mol %):

| | |
|---|---|
| Bismuth oxide | 30-60 |
| Rare earth compound | 0.01-8 (based on oxide) |
| SiO₂ | 0.5-40 |
| B₂O₃ | 0.5-40 |
| Al₂O₃ | 0-30 |
| Ga₂O₃ | 0-20 |
| Li₂O | 0-30 |
| La₂O₃ | 0-15 |
| GeO₂ | 0-25 |
| Nb₂O₅ | 0-10 |
| Sb₂O₃ | 0-10 |
| Na₂O | 0-40 |
| Rb₂O | 0-40 |
| SnO₂ | 0-30 |

The process according to the invention can also be used to produce cladding glasses for optical fiber amplifiers. Cladding glasses differ from the core glasses through the absence of a rare earth doping or through a rare earth doping which differs from the core, but are otherwise generally of similar composition.

The present invention also relates to a glass produced by the process according to the invention.

The present invention furthermore relates to the use of the process according to the invention for producing optical glasses, in particular optical glasses which are used in optical communication technology. Their use for fiber amplifiers and planar amplifiers in optical communication technology is particularly preferred. Furthermore, the process according to the invention can also be used to produce optically active glasses for laser technology.

### EXAMPLES

### Examples 1 and 9 and Comparative Example 1

Glasses were melted from raw materials which were pure but not optimized with regard to trace impurities at approx. 1100° C. in Pt-Ir crucibles. To stabilize the high oxidation state of the bismuth, dry oxygen gas was bubbled through the melt. After approx. 1.5 h including a standing time or stirring time to optimize the bubble quality, the liquid glass was poured into preheated graphite molds and cooled in a cooling furnace from T_{g} to room temperature at cooling rates of up to 15 K/h.

Table 1 lists the compositions from Examples 1 to 9 according to the invention and Comparative Example 1 (V1); no oxygen bubbling was carried out in the case of the Comparative Example.

It can be seen from the table below that the glasses according to the invention have maximum transmission of over 70%, whereas the glass of the Comparative Example has a maximum transmission of only below 60%.

Furthermore, the cerium-free glasses have a similarly low risetime to the cerium-containing glasses. Therefore, addition of cerium for spectroscopic reasons is not imperative.

TABLE 1

| | Ex. 1 | V1 | Ex. 2 | Ex. 3 | Ex. 4 | Ex. 5 | Ex. 6 | Ex. 7 | Ex. 8 | Ex. 9 |
|---|---|---|---|---|---|---|---|---|---|---|
| | (15470) | (14958) | (16812) | (16634) | (16872) | (16939) | (16606) | (16673) | (16779) | (16631) |
| SiO₂ | 33.11 | 33.11 | 14.15 | 14.39 | 14.43 | 13.97 | 31.50 | 27.97 | 14.09 | 14.36 |
| B₂O₃ | 24.54 | 24.54 | 28.60 | 28.36 | 21.41 | 27.67 | 23.34 | 20.73 | 28.45 | 28.32 |
| Bi₂O₃ | 42.29 | 42.29 | 42.90 | 42.37 | 50.01 | 41.77 | 37.84 | 33.61 | 42.64 | 42.24 |
| Al₂O₃ | — | — | 14.29 | 7.26 | 14.08 | 13.82 | — | — | 14.23 | 7.25 |
| Ga₂O₃ | — | — | — | 7.24 | — | — | — | — | | 7.23 |
| CeO₂ | — | — | — | — | — | — | — | — | 0.21 | 0.21 |
| CaO | — | — | — | — | — | — | — | 17.19 | — | — |
| BaO | — | — | — | — | — | — | 7.26 | — | — | — |
| Er₂O₃ | 0.06 | 0.06 | 0.06 | 0.38 | 0.07 | 2.77 | 0.06 | 0.5 | 0.38 | 0.39 |
| O₂ bubbling | Yes | No | Yes | Yes | Yes | Yes | Yes | Yes | Yes | Yes |
| Max transmission¹⁾ | 72.8 | <60 | 75.3 | 75.9 | 77.9 | 72.3 | 79.9 | 79.3 | 75.5 | 75.5 |
| n₁₃₀₀²⁾ | >2.1 | >2.1 | 1.9750 | 1.9943 | n.d.³⁾ | n.d. | 1.9812 | 1.9710 | 1.9743 | 1.9931 |
| λΔ[nm] (50% crit.)⁴⁾ | 49 | n.d. | 50 | 52 | 46 | 60 | 43 | 41 | 53 | 53 |
| λΔ[nm] (1/e crit.)⁵⁾ | 74 | n.d. | 75 | 80 | 70 | 89 | 60 | 53 | 79 | 79 |
| Risetime [μs]⁶⁾ | <1 μs | n.d. | <1 μs | <1 μs | <1 μs | <1 μs | <1 μs | <1 μs | <1 μs | <1 μs |

Notes:
¹⁾Maximum transmission in the wavelength range 250-2500 nm; measurement carried out on polished plane-parallel plates; thickness 10 mm.
²⁾Refractive index at the wavelength 1300 nm, measured using total reflection method on plane-parallel plates of 5 mm.
³⁾n.d.: not determined
⁴⁾Wavelength window at 50% of the maximum emission.
⁵⁾Wavelength window at 1/eth of the maximum emission.
⁶⁾“Risetime” is the time which is needed for the inversion of the energy level to build up after the pumping light has been switched on.

### Examples 10 and 11

Glasses having the compositions shown in Table 2 were melted at a temperature of 1000° C. The batches were dried prior to melting over P₂O₅ and dry oxygen was bubbled through during melting.

| | Ex. 10 | Ex. 11 |
|---|---|---|
| SiO₂ | 12.75 | 12.69 |
| B₂O₃ | 25.45 | 25.32 |
| Bi₂O₃ | 44.23 | 44.01 |
| Al₂O₃ | 7.57 | 7.53 |
| Li₂O | 10.00 | 9.95 |
| CeO₂ | — | 0.50 |
| O₂ Bubbling | Yes | Yes |
| Calculated proportion of Bi⁰ with | 0.015 | 0.055 |
| respect to total Bi₂O₃ in Mol % at | | |
| maximum melting temperature of | | |
| 1100° C. | | |
| Calculated proportion of Bi⁰ with | 0.002 | 0.008 |
| respect to total Bi₂O₃ in Mol % at | | |
| maximum melting temperature of | | |
| 1000° C. | | |

To calculate the proportion of Bi⁰ with respect to the total Bi₂O₃ content in Mol % as a function of the melting temperature, electrochemical measurements were carried out on the melts; dried oxygen was passed over the melt during these measurements.

The following redox reactions were assumed to take place in the melt:
Bi³⁺+3/2O²⁻ [symbol] Bi⁰+3/4O₂
Ce⁴⁺+1/2O²⁻ [symbol] Ce³⁺+1/4O₂
Bi³⁺+3Ce³⁺ [symbol] Bi⁰+3Ce⁴⁺(during cooling of the melt)

The equilibrium constants for the reactions are:
K[T,Bi]=[Bi⁰]*p(O₂)^{3/4}/[Bi³⁺]
K[T,Ce]=[Ce³⁺]*p(O₂)^{1/4}/[Ce⁴⁺]
ΔG°=−nF*E°(T)=ΔH°−TΔS°=−RT*In(K[T,i])

The proportion of Bi⁰ in the melt and in the cooled glass was determined in the following way:
E°(T) electrochemical (square-wave voltammetry)
ΔH° and ΔS° were determined from the temperature dependency of E°
the equilibrium constant K was determined from ΔH°and ΔS°
the Bi⁰ proportion was calculated from K in the melt using an oxygen partial pressure pO₂ of 1 bar (corresponding to an open system=melt)
the Ce³⁺ content was calculated in the same way as the Bi⁰ content in the melt

The Bi⁰ contents during cooling with the addition of CeO₂ can be calculated from the equilibrium constants K[T,Bi] and K[T,Ce].

The results of these calculations are shown FIGS. 3a and 3b.

1. A process for producing a glass containing bismuth oxide, characterized in that during the melting operation oxygen is blown into the melt.

2. The process as claimed in claim 1, in which dried oxygen is blown into the melt.

3. The process as claimed in claim 1 or 2, in which halogenated oxygen is blown into the melt.

4. The process as claimed in one of the preceding claims, in which a glass composition of the following composition is melted:

| | | |
|---|---|---|
| Bi₂O₃ | ≧10 | Mol % |
| further oxides | 0 to 90 | Mol % |
| rare earth compound | 0 to 8 | Mol % (based on oxide). |

5. The process as claimed in one of the preceding claims, in which a glass composition of the following composition (in Mol %) is melted:

| | |
|---|---|
| Bi₂O₃ | 30-60 |
| SiO₂ | 0-60 |
| GeO₂ | 0-30 |
| B₂O₃ | 0-60 |
| Al₂O₃ | 0-50 |
| Ga₂O₃ | 0-50 |
| In₂O₃ | 0-30 |
| WO₃ | 0-30 |
| MoO₃ | 0-30 |
| Nb₂O₅ | 0-30 |
| Sb₂O₃ | 0-30 |
| Ta₂O₅ | 0-15 |
| TiO₂ | 0-30 |
| ZrO₂ | 0-30 |
| SnO₂ | 0-40 |
| M^{I}₂O | 0-40 |
| M^{II}O | 0-30 |
| F and/or Cl | 0-10 |
| SiO₂ + GeO₂ | 0.5-60 |
| B₂O₃ + Al₂O₃ + Ga₂O₃ | 0.5-60 |
| rare earth compound | 0.005-8 (based on |
| | oxide) |

where M^{I} is at least one of Li, Na, K, Rb, Cs, and M^{II} is at least one of Be, Mg, Ca, Sr, Ba and/or Zn.

6. The process as claimed in claim 4 or 5, in which the rare earth compound used is Er.

7. The use of the process as claimed in one of claims 1 to 6 for the production of optical glasses.

8. The use as claimed in claim 7 for the production of glasses for optical communication technology.

9. The use as claimed in claim 7 or 8 for the production of glasses for optical amplifier media, such as fiber amplifiers and planar amplifiers.

10. A glass, producible by the process as claimed in one of claims 1 to 6.
